(19) United States
(12) Patent Application Publication
(10) Pub. No.: US 2026/0304547 A1
(43) Pub. Date: Oct. 1, 2026

(54) COMMUNICATION METHOD AND APPARATUS, AND READABLE STORAGE MEDIUM

(71) Applicant: BEIJING XIAOMI MOBILE SOFTWARE CO., LTD., Beijing (CN)

(72) Inventor: Ting FU, Beijing (CN)

(21) Appl. No.: 19/164,460

(22) PCT Filed: Mar. 15, 2023
(86) PCT No.: PCT/CN2023/081750

§ 371 Date: Sep. 11, 2025

(51) Int. Cl. H04W 76/28; H04W 72/231; H04W 80/02

(52) U.S. Cl. CPC H04W 76/28; H04W 72/231; H04W 80/02

(57) ABSTRACT

A communication method is performed by a network device and includes: transmitting configuration information to user equipment, where the configuration information is configured to determine configuration parameters of at least one discontinuous transmission and reception pattern corresponding to each of at least one serving carrier; and transmitting first indication information to the user equipment, where the first indication information is configured to activate a first discontinuous transmission and reception pattern among the at least one discontinuous transmission and reception pattern.

### CROSS REFERENCE TO RELATED APPLICATION

The present application is a U.S. National Stage of International Application No. PCT/CN2023/081750, filed on Mar. 15, 2023, the entire contents of which are incorporated herein by reference.

### BACKGROUND OF THE INVENTION

Network energy saving is one of the topics in Release 18 (R18) of the 3rd Generation Partnership Project (3GPP). A network energy saving project aims to study a technology for reducing energy consumption of a network device. One possible manner for network energy saving is a Discontinuous Transmission (DTX) mechanism or a Discontinuous Reception (DRX) mechanism of a base station.

The base station may affect signal transmission and reception of User Equipment (UE) during a DTX or DRX period.

### SUMMARY OF THE INVENTION

In a first aspect, the present disclosure provides a communication method performed by a network device. The method includes:
transmitting configuration information to user equipment, where the configuration information is configured to determine configuration parameters of at least one discontinuous transmission and reception pattern corresponding to each of at least one serving carrier; and
transmitting first indication information to the user equipment, where the first indication information is configured to activate a first discontinuous transmission and reception pattern among the at least one discontinuous transmission and reception pattern.

In a second aspect, the present disclosure provides a communication method performed by user equipment. The method includes:
receiving configuration information transmitted by a network device, where the configuration information is configured to determine configuration parameters of at least one discontinuous transmission and reception pattern corresponding to each of at least one serving carrier; and
receiving first indication information transmitted by the network device, where the first indication information is configured to activate a first discontinuous transmission and reception pattern among the at least one discontinuous transmission and reception pattern.

In a third aspect, the present disclosure provides a network device including a processor and a memory, where the memory is configured to store a computer program, and the processor is configured to execute the computer program to implement the method described in the first aspect.

In a fourth aspect, the present disclosure provides user equipment including a processor and a memory, where the memory is configured to store a computer program, and the processor is configured to execute the computer program to:
receive configuration information transmitted by a network device, where the configuration information is configured to determine configuration parameters of at least one discontinuous transmission and reception pattern corresponding to each of at least one serving carrier; and
receive first indication information transmitted by the network device, where the first indication information is configured to activate a first discontinuous transmission and reception pattern among the at least one discontinuous transmission and reception pattern.

### BRIEF DESCRIPTION OF DRAWINGS

The accompanying drawings described here are used to provide a further understanding of embodiments of the present disclosure, and constitute a part of the present disclosure. Examples of the embodiments of the present disclosure and their descriptions are used to explain the embodiments of the present disclosure, and do not constitute an improper limitation on the embodiments of the present disclosure.

The accompanying drawings here are incorporated into the specification and constitute a part of the specification. The accompanying drawings illustrate embodiments in accordance with the embodiments of the present disclosure, and are used to explain principles of the embodiments of the present disclosure together with the specification.

FIG. 1 is a schematic diagram of an architecture of a wireless communication system provided by an embodiment of the present disclosure.

FIG. 2 is a flowchart of an interaction of a communication method according to an example.

FIG. 3 is a schematic diagram of a discontinuous transmission and reception pattern according to an example.

FIG. 4 is a flowchart of a communication method according to an example.

FIG. 5 is a flowchart of a communication method according to another example.

FIG. 6 is a flowchart of a communication method according to another example.

FIG. 7 is a block diagram of a communication device according to an example.

FIG. 8 is a block diagram of a network device according to an example.

FIG. 9 is a block diagram of a communication device according to an example.

FIG. 10 is a block diagram of user equipment according to an example.

### DETAILED DESCRIPTION OF THE INVENTION

The embodiments of the present disclosure are further described with reference to the accompanying drawings and specific implementations.

The examples are described in detail here, and are shown in the accompanying drawings. When the following descriptions refer to the accompanying drawings, unless otherwise indicated, the same numerals in different drawings indicate the same or similar elements. Implementations described in the following examples do not represent all implementations consistent with the embodiments of the present disclosure. On the contrary, the implementations are merely examples of devices and methods consistent with some aspects of the present disclosure as detailed in the appended claims.

Terms used in the embodiments of the present disclosure are merely for describing specific embodiments and are not intended to limit the embodiments of the present disclosure. Singular forms “a/an” and “the” used in the embodiments and appended claims of the present disclosure are also intended to include plural forms, unless other meanings are clearly expressed in the context. It is also to be understood that the term “and/or” used herein refers to and includes any or all possible combinations of one or more associated listed items.

It is to be understood that although the terms such as first, second, and third may be used in the embodiments of the present disclosure to describe a variety of information, such information is not limited to these terms. These terms are merely used to distinguish information of the same type from each other. For example, without departing from the scope of the embodiments of the present disclosure, first information may also be referred to as second information, and similarly, the second information may also be referred to as the first information. Depending on the context, expressions “in a case where” and “in a case of” as used herein may be interpreted as “when,” “upon,” or “in response to determining”.

The embodiments of the present disclosure are described below in detail, and examples of the embodiments are shown in the accompanying drawings, where the same or similar reference numerals throughout represent the same or similar elements. The embodiments described below with reference to the drawings are illustrative, and are intended to explain the present disclosure rather than to be construed as limiting the present disclosure.

As shown in FIG. 1, a communication method provided by an embodiment of the present disclosure may be applied to a wireless communication system 100. The wireless communication system may include a network device 101 and user equipment 102, where the user equipment 102 is configured to support carrier aggregation and may be connected to a plurality of carrier units of the network device 101, including a main carrier unit and one or more auxiliary carrier units.

It is to be understood that the above wireless communication system 100 may be applicable to a low-frequency scenario, or may also be applicable to a high-frequency scenario. Application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system or a future evolved public land mobile network (PLMN) system, etc.

The user equipment 102 shown above may be a terminal, an access terminal, a terminal unit, a terminal station, a mobile station (MS), a remote station, a remote terminal, a mobile terminal, a wireless communication device, a terminal agent, or a terminal device, etc. The user equipment 102 may have a wireless transmission and reception function, and may communicate (e.g., wirelessly communicate) with one or more network devices of one or more communication systems and receive network services provided by the network device. The network device here includes, but is not limited to, the network device 101 shown in the drawings.

The user equipment 102 may be a cellular phone, a cordless phone, a session initiation protocol (SIP) phone, a wireless local loop (WLL) station, a personal digital assistant (PDA) device, a handheld device or a computing device having a wireless communication function, or other processing devices connected to a wireless modem, an in-vehicle device, a wearable device, a terminal in a future 5G network, or a terminal in a future evolved PLMN network, etc.

The network device 101 may be an access network device (or referred to as an access network website). The access network device refers to a device that provides a network access function, such as a radio access network (RAN) base station, etc. The network device 101 may specifically include a base station (BS), or includes the base station and a radio resource management device for controlling the base station, etc. The network device 101 may further include a relay station (relay device), an access point, and a base station in the future 5G network, a base station in the future evolved PLMN network, or an NR base station, etc. The network device 101 may be a wearable device or an in-vehicle device. The network device 101 may also be a communication chip having a communication module.

For example, the network device 101 includes, but is not limited to, a next generation node B (gnodeB, gNB) in 5G, an evolved node B (eNB) in the LTE system, a radio network controller (RNC), a node B (NB) in a WCDMA system, a radio controller in the CRAN system, a base station controller (BSC), a base transceiver station (BTS) in a GSM system or a CDMA system, a home base station (e.g., a home evolved nodeB or a home node B (HNB)), a baseband unit (BBU), a transmitting and receiving point (TRP), a transmitting point (TP), or a mobile switching center, etc.

In a network energy saving project, in order to ensure that the user equipment 102 may perform reasonable processing while the network device 101 is in a DTX or DRX, the network device 101 needs to inform the user equipment 102 in advance of a time-domain parameter of a DTX or DRX state.

The signaling overhead is lower in a case where the time-domain parameter of the DTX or DRX state is semi-statically configured via higher-layer signaling. However, when a service feature changes, the network device 101 needs to re-configure a time-domain parameter that matches the new service feature, or to un-configure the original time-domain parameter, which results in poor flexibility. Re-configuration of the time-domain parameter via the higher-layer signaling further needs a longer latency.

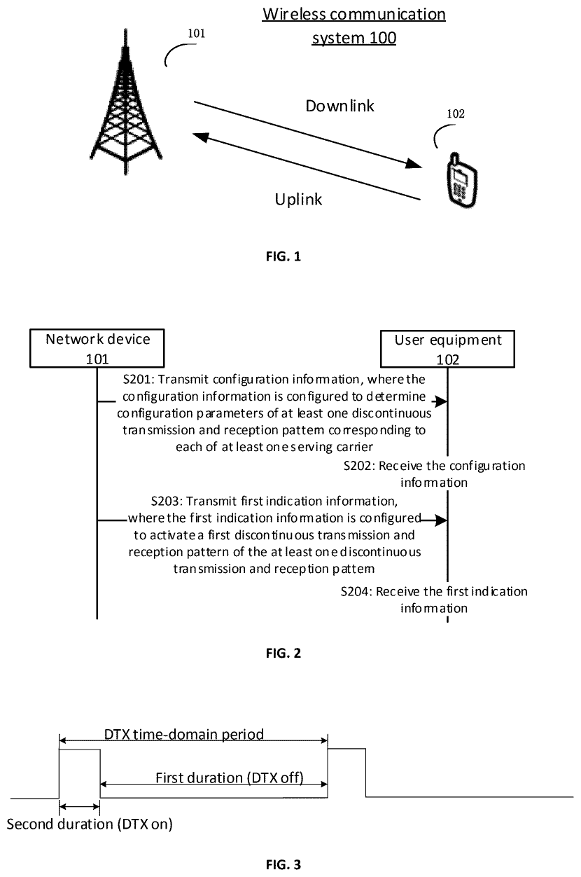

An embodiment of the present disclosure provides a communication method. Referring to FIG. 2, FIG. 2 is a flowchart of an interaction of a communication method according to an example. As shown in FIG. 2, the method includes steps S201 to S204.

Specifically, in step S201, a network device 101 transmits configuration information to user equipment 102. The configuration information is configured to determine configuration parameters of at least one discontinuous transmission and reception pattern corresponding to each of at least one serving carrier.

The serving carrier corresponds to a serving cell of the user equipment 102.

In some possible implementations, the network device 101 configures discontinuous transmission and reception patterns in a unit of carrier, for example, the network device 101 may configure one or more discontinuous transmission and reception patterns for each carrier. At least one configuration parameter is different between different discontinuous transmission and reception patterns.

In some possible implementations, when the network device 101 configures a plurality of discontinuous transmission and reception patterns for one carrier, each discontinuous transmission and reception pattern may be adapted to a corresponding service feature or service type, and thus the plurality of discontinuous transmission and reception patterns may match different service features or service types respectively.

In some possible implementations, the discontinuous transmission and reception pattern may include at least one of: a DRX pattern (a cell DRX on-off pattern), a DTX pattern (a cell DTX on-off pattern), or a DRX and DTX pattern pair (the cell DRX on-off pattern and the cell DTX on-off pattern).

For the DRX and DTX pattern pair, there is a correspondence between the DRX pattern and the DTX pattern. For example, the DRX and DTX pattern pair includes DRX patterns and corresponding DTX patterns which are bound one to one.

It is worth noting that there is a certain correlation between a DRX pattern and a DTX pattern of a cell. For example, in the DTX pattern, the cell may not transmit uplink/downlink scheduling information, or may also not transmit a reference signal. Correspondingly, during the corresponding duration in the DTX pattern, the user equipment 102 does not have uplink data scheduled and does not need to transmit a channel state information report (CSI report). Thus, the cell does not need to perform uplink reception. A state where the cell does not need to perform uplink reception may be considered as being in the DRX pattern. Therefore, the DRX and DTX pattern pair may be configured as needed in the embodiment of the present disclosure.

In some possible implementations, one cycle of the discontinuous transmission and reception pattern may include a first duration and a second duration. The first duration may be an energy saving duration, i.e., a duration during which the network device 101 skips data transmission and reception (an off duration). The second duration is a duration during which the network device 101 normally performs the data transmission and reception in the discontinuous transmission and reception pattern (an on duration).

In an example, the DRX pattern includes a first duration (a DRX-off duration) and a second duration (a DRX-on duration). For a cell configured with a cell DRX pattern, the network device 101 may skip reception of at least part of uplink information during the first duration, for example, the network device 101 does not receive some signals periodically transmitted by the user equipment 102. The network device 101 receives the uplink information normally during the second duration.

In an example, as shown in FIG. 3, the DTX pattern includes a first duration (a DTX-off duration) and a second duration (a DTX-on duration). For a cell configured with a cell DTX pattern, the network device 101 may skip transmission of at least part of downlink information during the first duration, for example, the network device 101 does not transmit some periodic signals. The network device 101 transmits the downlink information normally during the second duration.

Referring to the above examples of the states of the network device 101 in the discontinuous transmission and reception pattern, it can be known that the network device 101, when in the discontinuous transmission and reception pattern, affects signal transmission and reception of the user equipment 102.

In step S202, the user equipment 102 receives the configuration information.

In step S203, the network device 101 transmits first indication information to the user equipment 102. The first indication information is configured to activate a first discontinuous transmission and reception pattern among the at least one discontinuous transmission and reception pattern.

In some possible implementations, the first discontinuous transmission and reception pattern is a currently activated discontinuous transmission and reception pattern, and may be a discontinuous transmission and reception pattern that matches a current service feature.

In some possible implementations, the network device 101 may transmit the first indication information via Downlink Control Information (DCI) or a Media Access Control Control Element (MAC CE).

In some possible implementations, when the network device 101 configures a discontinuous transmission and reception pattern, the first indication information may indicate whether to activate the discontinuous transmission and reception pattern via a set information field.

In some possible implementations, when the network device 101 configures a plurality of discontinuous transmission and reception patterns, the first indication information may include an information field corresponding to each discontinuous transmission and reception pattern, and indicate whether to activate a corresponding discontinuous transmission and reception pattern via each information field.

In some possible implementations, in a case where a service feature changes, the network device 101 may activate a discontinuous transmission and reception pattern that matches the new service feature, and does not need to re-configure the discontinuous transmission and reception pattern via higher-layer signaling, so as to save the configuration latency.

In step S204, the user equipment 102 receives the first indication information.

In some possible implementations, the user equipment 102 may obtain an energy saving state of the network device 101 after receiving the first indication information, which facilitates adaptive operations. For example, when the network device 101 is in the first duration of the DTX pattern, the user equipment 102 may adaptively skip downlink reception to achieve energy saving of the user equipment 102.

In the embodiment of the present disclosure, the network device 101 configures one or more discontinuous transmission and reception patterns for the user equipment 102 by transmitting the configuration information to the user equipment 102, and indicates the currently activated first discontinuous transmission and reception pattern by transmitting the first indication information to the user equipment 102. Thus, the network device 101 activates the required discontinuous transmission and reception pattern by flexible signaling indication, which may not only save the configuration time, but also be beneficial for the user equipment 102 to adapt to the discontinuous transmission and reception pattern of the network device 101 to perform related operations.

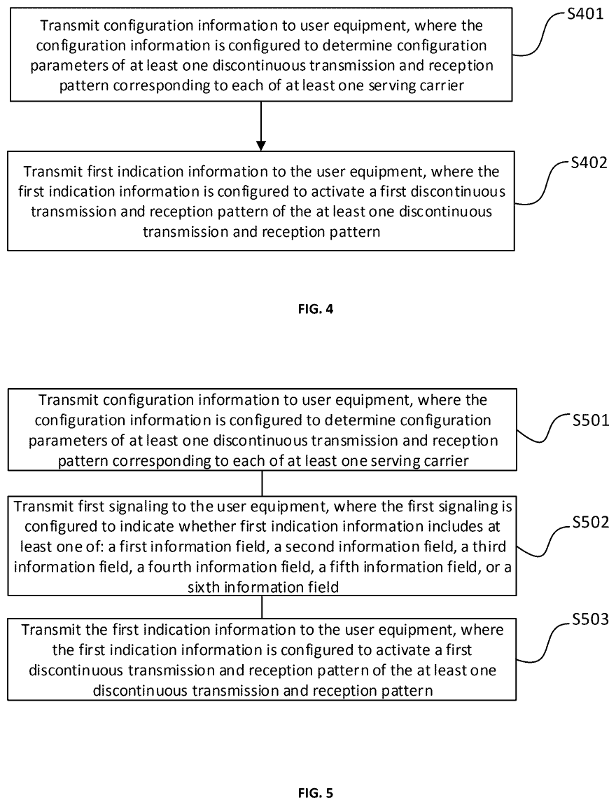

An embodiment of the present disclosure provides a communication method. The method is performed by a network device 101. Referring to FIG. 4, FIG. 4 is a flowchart of a communication method according to an example. As shown in FIG. 4, the method includes steps S401 and S402.

Specifically, in step S401, a network device 101 transmits configuration information to user equipment 102. The configuration information is configured to determine configuration parameters of at least one discontinuous transmission and reception pattern corresponding to each of at least one serving carrier.

The serving carrier corresponds to a serving cell of the user equipment 102.

In some possible implementations, the network device 101 configures discontinuous transmission and reception patterns in a unit of carrier, for example, the network device 101 may configure one or more discontinuous transmission and reception patterns for one carrier, and at least one configuration parameter is different between different discontinuous transmission and reception patterns. Alternatively, the network device 101 configures one or more discontinuous transmission and reception patterns for each of a plurality of carriers.

In some possible implementations, when the network device 101 configures a plurality of discontinuous transmission and reception patterns for one carrier, each discontinuous transmission and reception pattern may be adapted to a corresponding service feature or service type, and thus the plurality of discontinuous transmission and reception patterns may match different service features or service types respectively.

In some possible implementations, the discontinuous transmission and reception pattern includes one of:
a DRX pattern;
a DTX pattern; or
a DRX and DTX pattern pair, where the DRX and DTX pattern pair includes a DRX pattern and a DTX pattern corresponding to the DRX pattern.

In an example, the network device 101 configures a plurality of DRX patterns, a plurality of DTX patterns, or a plurality of DRX and DTX pattern pairs for one carrier.

In an example, each discontinuous transmission and reception pattern may be configured with corresponding configuration parameters.

In some possible implementations, the configuration parameters include at least one of:
a time-domain period;
a start offset;
a length of a first duration; or
a length of a second duration.

The first duration is a duration during which the network device skips data transmission and reception in the discontinuous transmission and reception pattern, and the second duration is a duration during which the network device performs the data transmission and reception in the discontinuous transmission and reception pattern.

In an example, one DRX time-domain period of the DRX pattern includes a first duration (a DRX-off duration) and a second duration (a DRX-on duration). The configuration parameters may include a value, a start offset, a length of the DRX-off duration, and a length of the DRX-on duration of the one DRX time-domain period.

In an example, one DTX time-domain period of the DTX pattern includes a first duration (a DTX-off duration) and a second duration (a DTX-on duration). The configuration parameters may include a value, a start offset, a length of the DTX-off duration, and a length of the DTX-on duration of the one DTX time-domain period.

In an example, configuration parameters of a DRX and DTX pattern pair include time-domain parameters of a DRX pattern and time-domain parameters of a DTX pattern corresponding to the DRX pattern. For example, the configuration parameters include a value, a start offset, a length of a DRX-off duration and a length of a DRX-on duration of a time-domain period of the DRX pattern, and a value, a start offset, a length of a DTX-off duration and a length of a DTX-on duration of a time-domain period of a DTX pattern corresponding to the DRX pattern.

In some possible implementations, different discontinuous transmission and reception patterns may have different configuration parameters.

For example, taking the DTX pattern as an example, the network device 101 configures two DTX patterns: Pattern 1 and Pattern 2. Pattern 1 has a longer time-domain period and is suitable for a scenario with sparse services. Pattern 2 has a shorter time-domain period and is suitable for a scenario with more frequent service arrival. In an example, the time-domain period of Pattern 1 may be an integer multiple of the time-domain cycle of Pattern 2.

In step S402, the network device 101 transmits first indication information to the user equipment 102. The first indication information is configured to activate a first discontinuous transmission and reception pattern among the at least one discontinuous transmission and reception pattern.

In some possible implementations, the first discontinuous transmission and reception pattern is a currently activated discontinuous transmission and reception pattern, and may be a discontinuous transmission and reception pattern that matches a current service feature.

In some possible implementations, the network device 101 may transmit the first indication information via DCI or an MAC CE.

In some possible implementations, in a case where a service feature changes, the network device 101 may activate a discontinuous transmission and reception pattern that matches the new service feature, and does not need to re-configure the discontinuous transmission and reception pattern via higher-layer signaling, so as to save the configuration latency.

In the embodiment of the present disclosure, the network device 101 configures one or more discontinuous transmission and reception patterns for the user equipment 102 by transmitting the configuration information to the user equipment 102, and indicates the currently activated first discontinuous transmission and reception pattern by transmitting the first indication information to the user equipment 102. Thus, the network device 101 activates the required discontinuous transmission and reception pattern by flexible signaling indication, so as to save the configuration time.

An embodiment of the present disclosure provides a communication method. The method is performed by a network device 101. The method includes steps S401 and S402.

Specifically, in step S401, a network device 101 transmits configuration information to user equipment 102. The configuration information is configured to determine configuration parameters of at least one discontinuous transmission and reception pattern corresponding to each of at least one serving carrier.

In step S402, the network device 101 transmits first indication information to the user equipment 102. The first indication information is configured to activate a first discontinuous transmission and reception pattern among the at least one discontinuous transmission and reception pattern.

The first indication information includes at least one of:
at least one first information field;
at least one second information field; or
at least one third information field.

The first information field is configured to indicate activation or inactivation of a corresponding DRX pattern, the second information field is configured to indicate activation or inactivation of a corresponding DTX pattern, and the third information field is configured to indicate activation or inactivation of a corresponding DRX and DTX pattern pair.

The implementations of steps S401 and S402 may be referred to the description of the aforementioned embodiment, which are not repeated here.

In some possible implementations, when the network device 101 transmits the first indication information via DCI or an MAC CE, the DCI or MAC CE may include at least one of a first information field, a second information field, or a third information field.

In some possible implementations, each first information field may include N1 bits, where N1 is greater than or equal to 1. Activation or inactivation of a corresponding DRX pattern is indicated via values of the N1 bits in the first information field. For example, the first information field being a set value represents inactivation of the DRX pattern.

In some possible implementations, each second information field may include N2 bits, where N2 is greater than or equal to 1. Activation or inactivation of a corresponding DTX pattern is indicated via values of the N2 bits in the second information field. For example, the second information field being a set value represents inactivation of the DTX pattern.

It is to be understood that the DRX pattern may be independently activated or inactivated according to the first information field, and the DTX pattern may be independently activated or inactivated according to the value of the second information field.

In some possible implementations, each third information field may include N3 bits, where N3 is greater than or equal to 1. Activation or inactivation of a corresponding DRX and DTX pattern pair is indicated via values of the N3 bits in the third information field. For example, the third information field being a set value represents inactivation of a group of DRX pattern and DTX pattern that are bound in a corresponding DRX and DTX pattern pair.

In the implementation, a DRX pattern and its corresponding DTX pattern are bound together to be activated or inactivated according to the value of the third information field.

In some possible implementations, each of the at least one first information field is configured to indicate activation or inactivation of a DRX pattern of a corresponding carrier, or is configured to indicate activation or inactivation of a DRX pattern of a corresponding carrier group.

In an example, N1 is 1 when the network device 101 configures one DRX pattern for one carrier, and N1 is greater than 1 when the network device 101 configures a plurality of DRX patterns for one carrier.

In an example, when there are a plurality of first information fields, the number of first information fields is related to the number of carriers. For example, there are M1 first information fields if the network device 101 configures at least one DRX pattern for each of M1 carriers. As shown in Table 1, each first information field corresponds to one carrier.

In an example, when there are a plurality of first information fields, the number of first information fields may also be related to the number of carrier groups. For example, the network device 101 configures at least one DRX pattern for each carrier group. As shown in Table 1, each first information field corresponds to one carrier group.

Each carrier group includes at least one carrier. Each carrier group corresponds to at least one DRX pattern. When a certain DRX pattern corresponding to a carrier group is activated, it is considered that the same DRX pattern is activated for each carrier in the carrier group.

TABLE 1

| | | |
|---|---|---|
| 1st first information field | Carrier 1 | Carrier group 1 |
| 2nd first information field | Carrier 2 | Carrier group 2 |
| . . . | . . . | . . . |
| M1-th first information field | Carrier M1 | Carrier group M1 |

In some possible implementations, each of the at least one second information field is configured to indicate activation or inactivation of a DTX pattern of a corresponding carrier, or is configured to indicate activation or inactivation of a DTX pattern of a corresponding carrier group.

In an example, N2 is 1 when the network device 101 configures one DTX pattern for one carrier, and N2 is greater than 1 when the network device 101 configures a plurality of DTX patterns for one carrier.

In an example, when there are a plurality of second information fields, as shown in Table 2, the number of second information fields is related to the number of carriers or the number of carrier groups. For example, there are M2 second information fields if the network device 101 configures at least one DTX pattern for each of M2 carriers. Alternatively, the network device 101 configures at least one DTX pattern group for each of M2 carrier groups.

Each carrier group corresponds to at least one DTX pattern. For a carrier group, the DTX pattern activated for each carrier in the carrier group are the same.

TABLE 2

| | | |
|---|---|---|
| 1st second information field | Carrier 1 | Carrier group 1 |
| 2nd second information field | Carrier 2 | Carrier group 2 |
| . . . | . . . | . . . |
| M2-th second information field | Carrier M2 | Carrier group M2 |

In some possible implementations, each of the at least one third information field is configured to indicate activation or inactivation of a DRX and DTX pattern pair of a corresponding carrier, or is configured to indicate activation or inactivation of a DRX and DTX pattern pair of a corresponding carrier group.

In an example, N3 is 1 when the network device 101 configures one DRX and DTX pattern pair for one carrier, and N3 is greater than 1 when the network device 101 configures a plurality of DRX and DTX pattern pairs for one carrier.

In an example, when there are a plurality of third information fields, as shown in Table 3, the number of third information fields is related to the number of carriers or the number of carrier groups. For example, there are M3 third information fields if the network device 101 configures at least one DRX and DTX pattern pair for each of M3 carriers. Alternatively, the network device 101 configures at least one DRX and DTX pattern pair group for each of M3 carrier groups.

Each carrier group corresponds to at least one DRX and DTX pattern pair. For a carrier group, the DRX and DTX pattern pair activated for each carrier in the carrier group are the same.

TABLE 3

| | | |
|---|---|---|
| 1st third information field | Carrier 1 | Carrier group 1 |
| 2nd third information field | Carrier 2 | Carrier group 2 |
| . . . | . . . | . . . |
| M3-th third information field | Carrier M3 | Carrier group M3 |

In the embodiment of the present disclosure, the network device 101 dynamically indicates, via different information fields in the first indication information, whether to activate a corresponding discontinuous transmission and reception pattern. Thus, in a scenario where the network device 101 configures a plurality of discontinuous transmission and reception patterns in a unit of carrier, the network device 101 may activate a required discontinuous transmission and reception pattern according to a current service feature, which has higher flexibility and may effectively save the configuration latency.

The embodiments of the present disclosure provide a communication method. The method is performed by a network device 101. The method includes steps S401 and S402.

Specifically, in step S401, a network device 101 transmits configuration information to user equipment 102. The configuration information is configured to determine configuration parameters of at least one discontinuous transmission and reception pattern corresponding to each of at least one serving carrier.

In step S402, the network device 101 transmits first indication information to the user equipment 102. The first indication information is configured to activate a first discontinuous transmission and reception pattern among the at least one discontinuous transmission and reception pattern.

The first indication information includes at least one of:
a fourth information field;
a fifth information field; or
a sixth information field.

The fourth information field is configured to indicate inactivation of all DRX patterns corresponding to all carriers of the user equipment, the fifth information field is configured to indicate inactivation of all DTX patterns corresponding to all the carriers of the user equipment, and the sixth information field is configured to indicate inactivation of all DRX and DTX pattern pairs corresponding to all the carriers of the user equipment.

The implementations of steps S401 and S402 may be referred to the description of the aforementioned embodiment, which are not repeated here.

In some possible implementations, when the network device 101 transmits the first indication information via DCI or an MAC CE, the DCI or MAC CE may include at least one of a fourth information field, a fifth information field, or a sixth information field.

In some possible implementations, the first indication information may further include at least one of a first information field, a second information field, or a third information field. In such case, the implementation may be referred to the description of the above-mentioned embodiment.

In some possible implementations, the fourth information field, when being a set value, is configured to inactivate all DRX patterns of all carriers of the UE.

In some possible implementations, the fifth information field, when being a set value, is configured to inactivate all DTX patterns of all the carriers of the UE.

In some possible implementations, the sixth information field, when being a set value, is configured to inactivate all DRX and DTX pattern pairs of all the carriers of the UE.

In the embodiment of the present disclosure, the network device 101 may inactivate a plurality of discontinuous transmission and reception patterns at a time via information fields in the first indication information, and thus signaling of the network device 101 may be saved.

An embodiment of the present disclosure provides a communication method. The method is performed by a network device 101. Referring to FIG. 5, FIG. 5 is a flowchart of a communication method according to an example. As shown in FIG. 5, the method includes steps S501 to S503.

Specifically, in step S501, a network device 101 transmits configuration information to user equipment 102. The configuration information is configured to determine configuration parameters of at least one discontinuous transmission and reception pattern corresponding to each of at least one serving carrier.

The implementation of step S501 may be referred to the implementation of step S401 of the aforementioned embodiment, which is not repeated here.

In step S502, the network device 101 transmits first signaling to the user equipment 102. The first signaling is configured to indicate whether first indication information includes at least one of: a first information field, a second information field, a third information field, a fourth information field, a fifth information field, or a sixth information field.

In step S503, the network device 101 transmits the first indication information to the user equipment 102. The first indication information is configured to activate a first discontinuous transmission and reception pattern among the at least one discontinuous transmission and reception pattern.

The implementation of step S503 may be referred to the implementation of step S402 of the aforementioned embodiment, which is not repeated here.

In some possible implementations, the first signaling may be higher-layer signaling, for example, Radio Resource Control (RRC) signaling.

In an example, the first signaling may be configured to indicate whether the first indication information includes the first information field, such that the user equipment 102 may determine, after receiving the first signaling and the first indication information, whether the network device 101 activates a corresponding DRX pattern according to a value of the first information field.

In an example, the first signaling may be configured to indicate whether the first indication information includes the second information field, such that the user equipment 102 may determine, after receiving the first signaling and the first indication information, whether the network device 101 activates a corresponding DTX pattern according to a value of the second information field.

In an example, the first signaling may be configured to indicate whether the first indication information includes the third information field, such that the user equipment 102 may determine, after receiving the first signaling and the first indication information, whether the network device 101 activates a corresponding DRX and DTX pattern pair according to a value of the third information field.

In an example, the first signaling may be configured to indicate whether the first indication information includes the fourth information field, such that the user equipment 102 may determine, after receiving the first signaling and the first indication information, whether the network device 101 inactivates all DRX patterns of all carriers of the UE according to a value of the fourth information field.

In an example, the first signaling may be configured to indicate whether the first indication information includes the fifth information field, such that the user equipment 102 may determine, after receiving the first signaling and the first indication information, whether the network device 101 inactivates all DTX patterns of all the carriers of the UE according to a value of the fifth information field.

In an example, the first signaling may be configured to indicate whether the first indication information includes the sixth information field, such that the user equipment 102 may determine, after receiving the first signaling and the first indication information, whether the network device 101 inactivates all DRX and DTX pattern pairs of all the carriers of the UE according to a value of the sixth information field.

It is to be understood that the first signaling in the above example may be different when indicating whether different information fields are included. For example, the first signaling indicating whether the second information field is included and the first signaling indicating whether the first information field is included may be different RRC signaling or the same RRC signaling. For another example, a plurality of pieces of first signaling may be used to respectively indicate whether the first information field, the second information field, the third information field, the fourth information field, the fifth information field, and the sixth information field are included.

In the embodiment of the present disclosure, the network device 101 informs the user equipment 102 in advance of the situation of information fields in the first indication information by transmitting the first signaling, and thus the user equipment 102 may obtain information of a corresponding information field in a targeted manner, which is conducive to improving signaling processing efficiency.

An embodiment of the present disclosure provides a communication method. The method is performed by a network device 101. The method includes steps S401 and S402, or includes steps S501 to S503.

The network device 101 may transmit first indication information via DCI or an MAC CE.

In a case where the first indication information is transmitted via the DCI, the DCI is one of:
unicast DCI;
multicast DCI; or
broadcast DCI.

In some possible implementations, Cyclic Redundancy Check (CRC) of the multicast DCI is scrambled using a first Radio Network Temporary Identity (RNTI), CRC of the broadcast DCI is scrambled using a second RNTI, and the unicast DCI is scrambled using a UE-specific RNTI.

The first RNTI is a common RNTI for a group of UE, and is configured by the network device 101. The second RNTI is a common RNTI for all UE in a cell, and may be configured by the network device 101 via broadcast signaling or defined by a protocol.

In a case where the first indication information is transmitted via the MAC CE, the MAC CE is UE-specific signaling.

In some possible implementations, the network device 101 may configure the same manner for transmitting an MAC CE for different user equipment 102.

In the embodiment of the present disclosure, the network device 101 may transmit the first indication information to the user equipment 102 in different transmission manners, so as to dynamically activate or inactivate a corresponding discontinuous transmission and reception pattern.

An embodiment of the present disclosure provides a communication method. The method is performed by a network device 101. The method includes steps S401 and S402′.

Specifically, in step S401, a network device 101 transmits configuration information to user equipment 102. The configuration information is configured to determine configuration parameters of at least one discontinuous transmission and reception pattern corresponding to each of at least one serving carrier.

In step S402′, the network device 101 transmits first indication information to the user equipment 102 on a primary cell, or transmits first indication information applicable to a secondary cell to the user equipment 102.

In some possible implementations, the network device 101 may transmit the first indication information via DCI or an MAC CE.

In some possible implementations, when the first indication information of the network device 101 is transmitted on the primary cell (Pcell), the user equipment 102 may monitor the first indication information merely on the primary cell, and does not need to monitor the first indication information on all serving cells or serving carriers, which may effectively reduce the monitoring energy consumption of the user equipment 102.

In some possible implementations, when the first indication information is merely applied to the secondary cell (scell), the discontinuous transmission and reception pattern is merely applied to the secondary cell, that is, the secondary cell enters the discontinuous transmission and reception pattern, and skips data transmission and reception during a certain duration. The primary cell may be in a service-available state at all times, which may thus avoid communication interruption between the user equipment 102 and the primary cell.

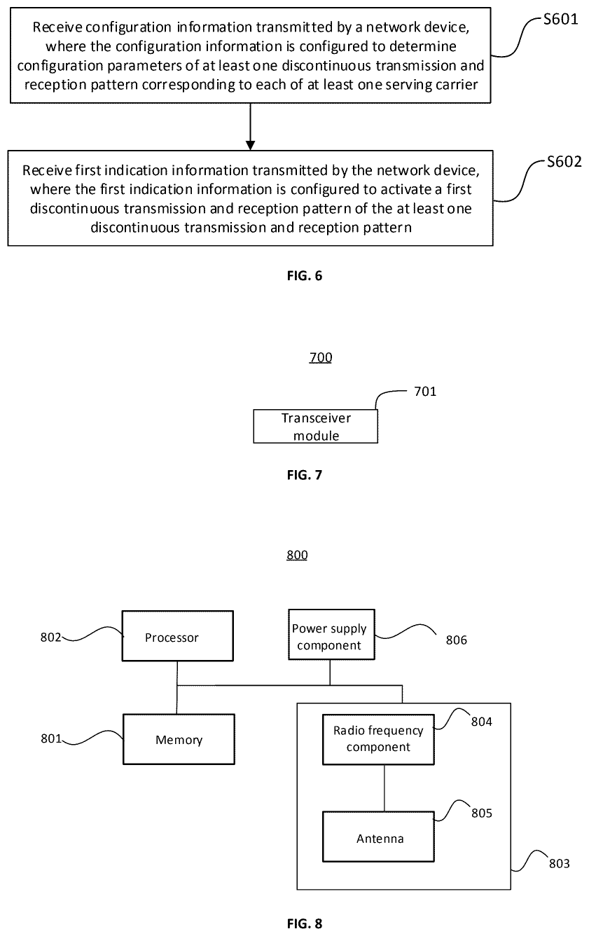

An embodiments of the present disclosure provides a communication method. The method is performed by user equipment 102. Referring to FIG. 6, FIG. 6 is a flowchart of a communication method according to an example. As shown in FIG. 6, the method includes steps S601 and S602.

Specifically, in step S601, the user equipment 102 receives configuration information transmitted by a network device 101. The configuration information is configured to determine configuration parameters of at least one discontinuous transmission and reception pattern corresponding to each of at least one serving carrier.

In some possible implementations, the network device 101 may configure one or more discontinuous transmission and reception patterns for one carrier, and at least one configuration parameter is different between different discontinuous transmission and reception patterns. Alternatively, the network device 101 configures one or more discontinuous transmission and reception patterns for each of a plurality of carriers.

In some possible implementations, at least one discontinuous transmission and reception pattern may be adapted to a corresponding service feature.

In some possible implementations, the discontinuous transmission and reception pattern includes one of:
a DRX pattern;
a DTX pattern; or
a DRX and DTX pattern pair, where the DRX and DTX pattern pair includes a DRX pattern and a DTX pattern corresponding to the DRX pattern.

In an example, the network device 101 configures a plurality of DRX patterns, a plurality of DTX patterns, or a plurality of DRX and DTX pattern pairs for one carrier.

In an example, each discontinuous transmission and reception pattern may be configured with corresponding configuration parameters.

In some possible implementations, the configuration parameters include at least one of:
a time-domain period;
a start offset;
a length of a first duration; or
a length of a second duration.

The first duration is a duration during which the network device skips data transmission and reception in the discontinuous transmission and reception pattern, and the second duration is a duration during which the network device performs the data transmission and reception in the discontinuous transmission and reception pattern.

The description of the implementation may be further referred to the implementation of the aforementioned embodiment, which is not fully repeated herein.

In step S602, the user equipment 102 receives first indication information transmitted by the network device 101. The first indication information is configured to activate a first discontinuous transmission and reception pattern among the at least one discontinuous transmission and reception pattern.

In some possible implementations, the first discontinuous transmission and reception pattern is a currently activated discontinuous transmission and reception pattern, and may be a discontinuous transmission and reception pattern that matches a current service feature.

In some possible implementations, the network device 101 may transmit the first indication information via DCI or an MAC CE.

In some possible implementations, in a case where a service feature changes, the network device 101 may activate a discontinuous transmission and reception pattern that matches the new service feature, and does not need to re-configure the discontinuous transmission and reception pattern via higher-layer signaling, so as to save the configuration latency.

In the embodiment of the present disclosure, the user equipment 102 receives the configuration parameters of at least one discontinuous transmission and reception pattern configured by the network device 101 by receiving the configuration information transmitted by the network device 101. The user equipment 102 obtains the currently activated first discontinuous transmission and reception pattern by receiving the first indication information. Thus, the network device 101 activates the required discontinuous transmission and reception pattern by flexible signaling indication, which may not only save the configuration time, but also be beneficial for the user equipment 102 to adapt to the discontinuous transmission and reception pattern of the network device to perform related operations.

An embodiment of the present disclosure provides a communication method. The method is performed by user equipment 102. The method includes steps S601 and S602.

Specifically, in step S601, the user equipment 102 receives configuration information transmitted by a network device 101. The configuration information is configured to determine configuration parameters of at least one discontinuous transmission and reception pattern corresponding to each of at least one serving carrier.

In step S602, the user equipment 102 receives first indication information transmitted by the network device 101. The first indication information is configured to activate a first discontinuous transmission and reception pattern among the at least one discontinuous transmission and reception pattern.

The implementations of steps S601 and S602 may be referred to the description of the aforementioned embodiment, which are not repeated here.

The first indication information includes at least one of:
at least one first information field;
at least one second information field; or
at least one third information field.

The first information field is configured to indicate activation or inactivation of a corresponding DRX pattern, the second information field is configured to indicate activation or inactivation of a corresponding DTX pattern, and the third information field is configured to indicate activation or inactivation of a corresponding DRX and DTX pattern pair.

In some possible implementations, the first information field may include N1 bits, the second information field may include N2 bits, and the third information field may include N3 bits.

In some possible implementations, each of the at least one first information field is configured to indicate activation or inactivation of a DRX pattern of a corresponding carrier, or is configured to indicate activation or inactivation of a DRX pattern of a corresponding carrier group.

The implementation may be referred to the description of the aforementioned embodiment, such as the implementation corresponding to Table 1, which is not repeated here.

In some possible implementations, each of the at least one second information field is configured to indicate activation or inactivation of a DTX pattern of a corresponding carrier, or is configured to indicate activation or inactivation of a DTX pattern of a corresponding carrier group.

The implementation may be referred to the description of the aforementioned embodiment, such as the implementation corresponding to Table 2, which is not repeated here.

In some possible implementations, each of the at least one third information field is configured to indicate activation or inactivation of a DRX and DTX pattern pair of a corresponding carrier, or is configured to indicate activation or inactivation of a DRX and DTX pattern pair of a corresponding carrier group.

The implementation may be referred to the description of the aforementioned embodiment, such as the implementation corresponding to Table 3, which is not repeated here.

In the embodiment of the present disclosure, the user equipment 102 may obtain, according to values of different information fields in the first indication information, the activated discontinuous transmission and reception pattern dynamically indicated by the network device 101, which has higher flexibility.

An embodiment of the present disclosure provides a communication method. The method is performed by user equipment 102. The method includes steps S601 and S602.

Specifically, in step S601, the user equipment 102 receives configuration information transmitted by a network device 101. The configuration information is configured to determine configuration parameters of at least one discontinuous transmission and reception pattern corresponding to each of at least one serving carrier.

In step S602, the user equipment 102 receives first indication information transmitted by the network device 101. The first indication information is configured to activate a first discontinuous transmission and reception pattern among the at least one discontinuous transmission and reception pattern.

The implementations of steps S601 and S602 may be referred to the description of the aforementioned embodiment, which are not repeated here.

The first indication information includes at least one of:
a fourth information field;
a fifth information field; or
a sixth information field.

The fourth information field is configured to indicate inactivation of all DRX patterns corresponding to all carriers of the user equipment, the fifth information field is configured to indicate inactivation of all DTX patterns corresponding to all the carriers of the user equipment, and the sixth information field is configured to indicate inactivation of all DRX and DTX pattern pairs corresponding to all the carriers of the user equipment.

In some possible implementations, when the network device 101 transmits the first indication information via DCI or an MAC CE, the DCI or MAC CE may include at least one of a fourth information field, a fifth information field, or a sixth information field.

In some possible implementations, the first indication information may further include at least one of a first information field, a second information field, or a third information field. In such case, the implementation may be referred to the description of the above-mentioned embodiment.

In some possible implementations, the fourth information field, when being a set value, is configured to inactivate all DRX patterns of all carriers of the UE. The fifth information field, when being a set value, is configured to inactivate all DTX patterns of all the carriers of the UE. The sixth information field, when being a set value, is configured to inactivate all DRX and DTX pattern pairs of all the carriers of the UE.

In the embodiment of the present disclosure, the user equipment 102 may obtain, via values of information fields in the first indication information, whether the network device 101 inactivates a plurality of discontinuous transmission and reception patterns at a time, and thus signaling of the network device 101 may be saved.

An embodiment of the present disclosure provides a communication method. The method is performed by user equipment 102. The method includes steps S601, S600, and S602.

Specifically, in step S601, the user equipment 102 receives configuration information transmitted by a network device 101. The configuration information is configured to determine configuration parameters of at least one discontinuous transmission and reception pattern corresponding to each of at least one serving carrier.

In step S600, first signaling transmitted by the network device is received. The first signaling is configured to indicate whether first indication information includes at least one of: a first information field, a second information field, a third information field, a fourth information field, a fifth information field, or a sixth information field.

In step S602, the user equipment 102 receives the first indication information transmitted by the network device 101. The first indication information is configured to activate a first discontinuous transmission and reception pattern among the at least one discontinuous transmission and reception pattern.

In some possible implementations, the first signaling may be higher-layer signaling, for example, RRC signaling.

It is to be understood that the implementation of the embodiment of the present disclosure may be referred to the description of the aforementioned embodiment, which is not repeated here.

In the embodiment of the present disclosure, the user equipment 102 obtains the situation of information fields in the first indication information according to the first signaling transmitted by the network device 101, and thus the user equipment 102 may obtain information of a corresponding information field in a targeted manner, which is conducive to improving signaling processing efficiency.

An embodiment of the present disclosure provides a communication method. The method is performed by user equipment 102. The method includes steps S601 and S602, or the method includes steps S601, S600, and S602.

The network device 101 may transmit first indication information via DCI or an MAC CE.

In a case where the first indication information is transmitted via the DCI, the DCI is one of:
unicast DCI;
multicast DCI; or
broadcast DCI.

In some possible implementations, CRC of the multicast DCI is scrambled using a first RNTI, CRC of the broadcast DCI is scrambled using a second RNTI, and the unicast DCI is scrambled using a UE-specific RNTI.

The first RNTI is a common RNTI for a group of UE, and is configured by the network device 101. The second RNTI is a common RNTI for all UE in a cell, and may be configured by the network device 101 via broadcast signaling or defined by a protocol.

In a case where the first indication information is transmitted via the MAC CE, the MAC CE is UE-specific signaling.

In some possible implementations, the network device 101 may configure the same manner for transmitting an MAC CE for different user equipment 102.

In the embodiment of the present disclosure, the network device 101 may transmit the first indication information to the user equipment 102 in different transmission manners, so as to dynamically activate or inactivate a corresponding discontinuous transmission and reception pattern.

An embodiment of the present disclosure provides a communication method. The method is performed by user equipment 102. The method includes steps S601 and S602′.

Specifically, in step S601, the user equipment 102 receives configuration information transmitted by a network device 101. The configuration information is configured to determine configuration parameters of at least one discontinuous transmission and reception pattern corresponding to each of at least one serving carrier.

In step S602′, the user equipment 102 receives first indication information transmitted by the network device 101 on a primary cell, or receives first indication information that is applicable to a secondary cell and transmitted by the network device.

In some possible implementations, the network device 101 may transmit the first indication information via DCI or an MAC CE.

In some possible implementations, in a case where the first indication information is transmitted on the primary cell, the method may further include the following step. The user equipment 102 monitors the first indication information on a carrier corresponding to the primary cell.

In this step, when the first indication information is transmitted on the primary cell (Pcell), the user equipment 102 may monitor the first indication information merely on the primary cell, and does not need to monitor the first indication information on all serving cells or serving carriers, which may effectively reduce the monitoring energy consumption of the user equipment 102.

In some possible implementations, in a case where the first indication information is applicable to the secondary cell, the method may further include the following step. The user equipment 102 communicates with the secondary cell according to the first indication information.

In this step, when the first indication information is merely applied to the secondary cell (scell), the discontinuous transmission and reception pattern is merely applied to the secondary cell, that is, the secondary cell enters the discontinuous transmission and reception pattern, and skips data transmission and reception during a certain duration. The user equipment 102 needs to perform an adaptive operation when the secondary cell skips the data transmission and reception. For example, in a case where the secondary cell is in a DRX pattern, the secondary cell skips uplink data reception during a first duration, and the user equipment 102 may skip uplink data transmission during the first duration.

In this step, the primary cell may be in a service-available state at all times, which may thus avoid communication interruption between the user equipment 102 and the primary cell.

An embodiment of the present disclosure provides a communication method. The method is performed by user equipment 102. The method includes steps S601 and S602.

Specifically, in step S601, the user equipment 102 receives configuration information transmitted by a network device 101. The configuration information is configured to determine configuration parameters of at least one discontinuous transmission and reception pattern corresponding to each of at least one serving carrier.

In step S602, the user equipment 102 receives first indication information transmitted by the network device 101. The first indication information is configured to activate a first discontinuous transmission and reception pattern among the at least one discontinuous transmission and reception pattern.

The first discontinuous transmission and reception pattern is activated at a moment when the user equipment 102 receives the first indication information.

In some possible implementations, the first discontinuous transmission and reception pattern may be a DRX pattern, a DTX pattern, or a DRX and DTX pattern pair.

In some possible implementations, the moment when the first indication information is received refers to a moment when the first indication information is monitored and processing of the first indication information, such as demodulation, is completed.

In some possible implementations, in a scenario where the first discontinuous transmission and reception pattern is activated, the network device 101 may apply the first discontinuous transmission and reception pattern. For example, during the time-domain period of the first discontinuous transmission and reception pattern, data transmission and reception is skipped during a first duration, and the data transmission and reception is normally performed during a second duration.

In some possible implementations, when the network device 101 is in the first discontinuous transmission and reception pattern, the user equipment 102 may also perform adaptive energy saving operations. For example, when the network device 101 does not transmit downlink information during the first duration, the user equipment 102 may not monitor the downlink information during the first duration to achieve energy saving.

An embodiment of the present disclosure provides a communication method. The method is performed by user equipment 102. The method includes steps S601 to S603.

Specifically, in step S601, the user equipment 102 receives configuration information transmitted by a network device 101. The configuration information is configured to determine configuration parameters of at least one discontinuous transmission and reception pattern corresponding to each of at least one serving carrier.

In step S602, the user equipment 102 receives first indication information transmitted by the network device 101. The first indication information is configured to activate a first discontinuous transmission and reception pattern among the at least one discontinuous transmission and reception pattern.

The first discontinuous transmission and reception pattern is activated at a moment when the user equipment 102 receives the first indication information.

In step S603, a second discontinuous transmission and reception pattern is activated after a second time-domain position when second indication information corresponding to the second discontinuous transmission and reception pattern is received at a first time-domain position. The first time-domain position is within a time-domain period of the first discontinuous transmission and reception pattern.

In some possible implementations, the first time-domain position may be within the time-domain period corresponding to the first discontinuous transmission and reception pattern, for example, within the first duration or the second duration of the first discontinuous transmission and reception pattern.

In some possible implementations, information formats or transmission manners of the second indication information and the first indication information may be the same. For example, the second indication information may include a first information field, a second information field, or a third information field.

In some possible implementations, the second discontinuous transmission and reception pattern may also be referred to the description of the first discontinuous transmission and reception pattern. Configuration parameters of the second discontinuous transmission and reception pattern are different from those of the first discontinuous transmission and reception pattern, for example, time-domain periods of the two are different, so as to apply to different service features.

In some possible implementations, the second time-domain position is one of:
a next slot of the first time-domain position;
a slot after a plurality of slots following the first time-domain position;
a moment after the first time-domain position, at which a timer corresponding to the first discontinuous transmission and reception pattern expires; or
a moment after the first time-domain position, at which a first period of the first discontinuous transmission and reception pattern ends, where the first period is the time-domain period of the first discontinuous transmission and reception pattern in which the first time-domain position is located.

In an example, when the network device 101 transmits the second indication information via DCI, if the first time-domain position at which the user equipment 102 receives the second indication information is slot1, the second discontinuous transmission and reception pattern may be activated at a next slot after slot1, such as slot2 (i.e., the second time-domain position).

In an example, when the network device 101 transmits the second indication information via an MAC CE, if the first time-domain position at which the user equipment 102 receives the second indication information is slot1, the second discontinuous transmission and reception pattern may be activated after K slots following slot1, such as (slot1+K) (i.e., the second time-domain position). The K slots may be a demodulation duration for the user equipment 102 to demodulate the MAC CE.

In an example, the timer corresponding to the first discontinuous transmission and reception pattern is, for example, a running timer of the second duration (on duration). For example, the second discontinuous transmission and reception pattern is activated at a moment when a DRX-on duration timer expires in a DRX pattern, or at a moment when a DTX-on duration timer expires in a DTX pattern.

In an example, the first period is a current time-domain period during which the second indication information is received in the first discontinuous transmission and reception pattern. The network device 101 applies the second discontinuous transmission and reception pattern at a moment when the current time-domain period ends.

In the embodiment of the present disclosure, the user equipment 102 receives the second indication information during an activation period of the first discontinuous transmission and reception pattern, and may determine an effective position of the second indication information according to the time-domain position when the second indication information is received. Thus, the user equipment 102 may determine the time-domain position when the network device 101 activates the second discontinuous transmission and reception pattern, so as to perform a corresponding energy-saving operation.

An embodiment of the present disclosure further provides a communication device based on the same concept as the above-mentioned method embodiments. The device may have functions of the network device 101 in the above-mentioned method embodiments, and may be configured to perform the steps that are provided by the above-mentioned method embodiments and performed by the network device 101. The functions may be implemented by hardware, by software, or by executing corresponding software by the hardware. The hardware or software includes one or more modules corresponding to the above-mentioned functions.

In one possible implementation, a device 700 shown in FIG. 7 may serve as the network device 101 involved in the above-mentioned method embodiments, and perform the steps that are performed by the network device 101 in the above-mentioned method embodiments. As shown in FIG. 7, the device 700 may include a transceiver module 701. The transceiver module 701 may be configured to support the communication device for communication, and the transceiver module 701 may have a wireless communication function, for example, may perform wireless communication with other communication devices via a wireless air interface.

The transceiver module 701, when performing the steps performed by the network device 101, is configured to transmit configuration information to user equipment. The configuration information is configured to determine configuration parameters of at least one discontinuous transmission and reception pattern corresponding to each of at least one serving carrier.

The transceiver module 701 is further configured to transmit first indication information to the user equipment. The first indication information is configured to activate a first discontinuous transmission and reception pattern among the at least one discontinuous transmission and reception pattern.

When the communication device is the network device 101, its structure may be as shown in FIG. 8. The structure of the communication device is described taking a base station as an example. As shown in FIG. 8, the device 800 includes a memory 801, a processor 802, a transceiver component 803, and a power supply component 806. The memory 801 is coupled to the processor 802, and may be configured to store programs and data that are necessary for the communication device 800 to implement various functions. The processor 802 is configured to support the communication device 800 in performing corresponding functions in the above-mentioned methods, and the functions may be implemented by calling the programs stored in the memory 801. The transceiver component 803 may be a radio transceiver, and may be configured to support the communication device 800 in receiving and transmitting signaling and/or data via a wireless air interface. The transceiver component 803 may also be referred to as a transceiver unit or a communication unit. The transceiver component 803 may include a radio frequency component 804 and one or more antennas 805. The radio frequency component 804 may be a remote radio unit (RRU), and may be specifically configured to transmit radio frequency signals, and perform conversion between radio frequency signals and baseband signals. The one or more antennas 805 may be specifically configured to radiate and receive radio frequency signals.

When the communication device 800 needs to transmit data, the processor 802 may perform baseband processing on the data to be transmitted, and then output a baseband signal to the radio frequency unit. The radio frequency unit performs radio frequency processing on the baseband signal and then transmits a radio frequency signal via the antenna in a form of an electromagnetic wave. When data is transmitted to the communication device 800, the radio frequency unit receives a radio frequency signal via the antenna, converts the radio frequency signal into a baseband signal, and outputs the baseband signal to the processor 802. The processor 802 converts the baseband signal into data and processes the data.

An embodiment of the present disclosure further provides a communication device based on the same concept as the above-mentioned method embodiments. The device may have functions of the user equipment 102 in the above-mentioned method embodiments, and may be configured to perform the steps that are provided by the above-mentioned method embodiments and performed by the user equipment 102. The functions may be implemented by hardware, by software, or by executing corresponding software by the hardware. The hardware or software includes one or more modules corresponding to the above-mentioned functions.

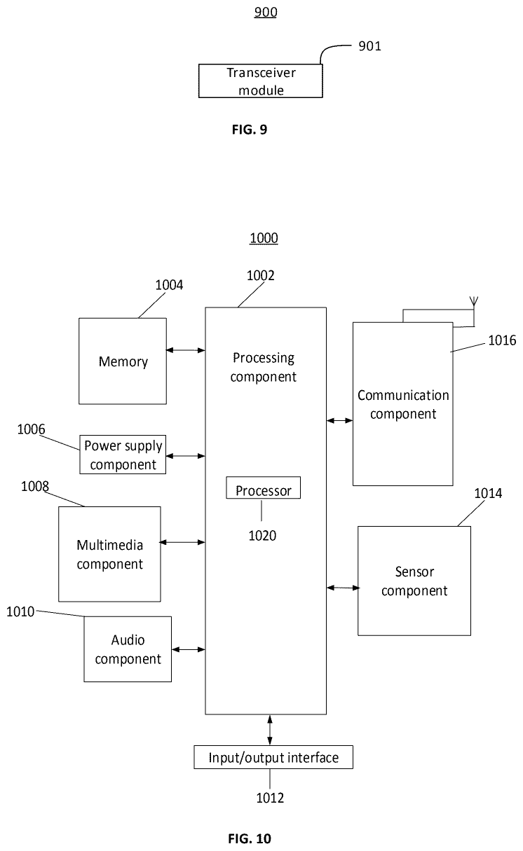

In one possible implementation, a device 900 shown in FIG. 9 may serve as the user equipment 102 involved in the above-mentioned method embodiments, and perform the steps that are performed by the user equipment 102 in the above-mentioned method embodiments. As shown in FIG. 9, the device 900 may include a transceiver module 901. The transceiver module 901 may be configured to support the communication device for communication.

The transceiver module 901, when performing the steps performed by the user equipment 102, is configured to receive configuration information transmitted by a network device. The configuration information is configured to determine configuration parameters of at least one discontinuous transmission and reception pattern corresponding to each of at least one serving carrier.

The transceiver module 901 is further configured to receive first indication information transmitted by the network device. The first indication information is configured to activate a first discontinuous transmission and reception pattern among the at least one discontinuous transmission and reception pattern.

When the device is the user equipment 102, its structure may further be as shown in FIG. 10. The device 1000 may be a mobile phone, a computer, a digital broadcasting terminal, a message transceiver device, a game console, a tablet device, a medical device, a fitness device, a personal digital assistant, etc.

Referring to FIG. 10, the device 1000 may include one or more of the following components: a processing component 1002, a memory 1004, a power supply component 1006, a multimedia component 1008, an audio component 1100, an input/output (I/O) interface 1012, a sensor component 1014, and a communication component 1016.

The processing component 1002 generally controls overall operations of the device 1000, such as operations associated with display, telephone calls, data communication, camera operations, and recording operations. The processing component 1002 may include one or more processors 1020 to execute instructions to complete all or part of the steps of the above-mentioned methods. Furthermore, the processing component 1002 may include one or more modules to facilitate interaction between the processing component 1002 and other components. For example, the processing component 1002 may include a multimedia module to facilitate interaction between the multimedia component 1008 and the processing component 1002.

The memory 1004 is configured to store various types of data to support operations on the device 1000. Examples of such data include instructions for any applications or methods operated on the device 1000, contact data, phone book data, messages, pictures, videos, and the like. The memory 1004 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic, or an optical disk.

The power supply component 1006 supplies power to various components of the device 1000. The power supply component 1006 may include a power management system, one or more power supplies, and other components associated with generation, management, and distribution of power for the device 1000.

The multimedia component 1008 includes a screen providing an output interface between the device 1000 and a user. In some embodiments, the screen may include a liquid crystal display (LCD) and a touch panel (TP). The screen, in a case of including the touch panel, may be implemented as a touch screen to receive an input signal from the user. The touch panel includes one or more touch sensors to sense touches, swipes, and gestures on the touch panel. The touch sensor may not only sense a boundary of a touch or swipe action but also detect a duration and pressure associated with the touch or swipe operation. In some embodiments, the multimedia component 1008 includes a front camera and/or a rear camera. In a case where the device 1000 is in an operational mode, such as a photographing mode or a video mode, the front camera and/or the rear camera may receive external multimedia data. Each of the front camera and the rear camera may be a fixed optical lens system or have a focal length and an optical zoom capability.

The audio component 1100 is configured to output and/or input an audio signal. For example, the audio component 1100 includes one microphone (MIC). In a case where the device 1000 is in an operational mode, such as a call mode, a recording mode, and a voice recognition mode, the microphone is configured to receive an external audio signal. The received audio signal may further be stored in the memory 1004 or transmitted via the communication component 1016. In some embodiments, the audio component 1100 further includes a speaker configured to output the audio signal.

The I/O interface 1012 provides an interface between the processing component 1002 and a peripheral interface module, and the above-mentioned peripheral interface module may be a keyboard, a click wheel, a button, or the like. The button may include, but is not limited to, a home button, a volume button, a start button, and a lock button.

The sensor component 1014 includes one or more sensors configured to provide state assessment in various aspects for the device 1000. For example, the sensor component 1014 may detect an on/off state of the device 1000 and relative positioning of the components, for example, the components are a display and a small keyboard of the device 1000. The sensor component 1014 may further detect a change in the position of the device 1000 or a component of the device 1000, presence or absence of contact between the user and the device 1000, orientation or acceleration/deceleration of the device 1000, and a change in the temperature of the device 1000. The sensor component 1014 may include a proximity sensor configured to detect presence of a nearby object without any physical contact. The sensor component 1014 may further include a light sensor, such as a CMOS or a CCD image sensor, which is configured to be used in an imaging application. In some embodiments, the sensor component 1014 may further include an acceleration sensor, a gyroscope sensor, a magnetic sensor, a pressure sensor, or a temperature sensor.

The communication component 1016 is configured to facilitate wired or wireless communication between the device 1000 and other devices. The device 1000 may access a communication-standard-based wireless network, such as Wi-Fi, 2G or 3G, or a combination thereof. In one example, the communication component 1016 receives a broadcast signal or broadcast-related information from an external broadcast management system via a broadcast channel. In one example, the communication component 1016 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the device 1000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements, and is configured to perform the above-mentioned methods.

In an example, a non-transitory computer-readable storage medium including instructions is further provided, such as a memory 1004 including instructions. The above-mentioned instructions may be executed by a processor 1020 of a device 1000 to complete the above-mentioned methods. For example, the non-transitory computer-readable storage medium may be an ROM, a random access memory (RAM), a CD-ROM, a magnetic tape, a floppy disk, an optical data storage device, etc.

Other implementations of the embodiments of the present disclosure will be readily apparent to those skilled in the art upon consideration of the specification and practice of the invention disclosed here. The present disclosure is intended to cover any variations, applications, or adaptations of the embodiments of the present disclosure, and these variations, applications, or adaptions follow the general principles of the embodiments of the present disclosure and include common knowledge or conventional technical means in the technical field that are not disclosed by the present disclosure. The specification and embodiments are merely regarded as illustrative, and the true scope and spirit of the embodiments of the present disclosure are indicated by the following claims.

It is to be understood that the embodiments of the present disclosure are not limited to the precise structures that have been described above and shown in the drawings, and various modifications and changes may be made without departing from the scope. The scope of the embodiments of the present disclosure is merely limited by the appended claims.

### INDUSTRIAL APPLICABILITY

In the method of the present disclosure, the network device configures one or more discontinuous transmission and reception patterns for the user equipment by transmitting the configuration information to the user equipment, and indicates the currently activated first discontinuous transmission and reception pattern by transmitting the first indication information to the user equipment. Thus, the network device activates the required discontinuous transmission and reception pattern by flexible signaling indication, which may not only save the configuration time, but also be beneficial for the user equipment to adapt to the discontinuous transmission and reception pattern of the network device to perform related operations.

1. A communication method, performed by a network device, the communication method comprising:
transmitting configuration information to user equipment, wherein the configuration information is configured to determine configuration parameters of at least one discontinuous transmission and reception pattern corresponding to each of at least one serving carrier; and
transmitting first indication information to the user equipment, wherein the first indication information is configured to activate a first discontinuous transmission and reception pattern among the at least one discontinuous transmission and reception pattern.

2. The communication method according to claim 1, wherein the at least one discontinuous transmission and reception pattern comprises one of the following:
a Discontinuous Reception (DRX) pattern;
a Discontinuous Transmission (DTX) pattern; or
a Discontinuous Reception (DRX) and Discontinuous Transmission (DTX) pattern pair, wherein the DRX and DTX pattern pair comprises a DRX pattern and a DTX pattern corresponding to the DRX pattern.

3. The communication method according to claim 1, wherein the first indication information comprises at least one of the following:
at least one first information field;
at least one second information field; or
at least one third information field,
wherein the at least one first information field is configured to indicate activation or inactivation of a corresponding Discontinuous Reception (DRX) pattern, the at least one second information field is configured to indicate activation or inactivation of a corresponding Discontinuous Transmission (DTX) pattern, and the at least one third information field is configured to indicate activation or inactivation of a corresponding DRX and DTX pattern pair.

4. The communication method according to claim 3, wherein at least one of the following cases exists:
a case where each of the at least one first information field is configured to indicate activation or inactivation of a DRX pattern of a corresponding carrier, or is configured to indicate activation or inactivation of a DRX pattern of a corresponding carrier group;
a case where each of the at least one second information field is configured to indicate activation or inactivation of a DTX pattern of a corresponding carrier, or is configured to indicate activation or inactivation of a DTX pattern of a corresponding carrier group; or
a case where each of the at least one third information field is configured to indicate activation or inactivation of a DRX and DTX pattern pair of a corresponding carrier, or is configured to indicate activation or inactivation of a DRX and DTX pattern pair of a corresponding carrier group.

5-6. (canceled)

7. The communication method according to claim 1, wherein the first indication information comprises at least one of the following:
a fourth information field;
a fifth information field; or
a sixth information field,
wherein the fourth information field is configured to indicate inactivation of all Discontinuous Reception (DRX) patterns corresponding to all carriers of the user equipment, the fifth information field is configured to indicate inactivation of all Discontinuous Transmission (DTX) patterns corresponding to all the carriers of the user equipment, and the sixth information field is configured to indicate inactivation of all DRX and DTX pattern pairs corresponding to all the carriers of the user equipment.

8. The communication method according to claim 3, further comprising:
transmitting first signaling to the user equipment, wherein the first signaling is configured to indicate whether the first indication information comprises at least one of the following: the at least one first information field, the at least one second information field, the at least one third information field, a fourth information field, a fifth information field, or a sixth information field.

9. The communication method according to claim 1, wherein the first indication information is transmitted via Downlink Control Information (DCI) or a Media Access Control Control Element (MAC CE);
wherein the DCI is one of the following:
unicast DCI;
multicast DCI; or
broadcast DCI;
and the MAC CE is UE-specific signaling.

10. (canceled)

11. The communication method according to claim 1, wherein transmitting the first indication information to the user equipment comprises:
transmitting the first indication information to the user equipment on a primary cell, or transmitting the first indication information applicable to a secondary cell to the user equipment.

12. The communication method according to claim 1, wherein the configuration parameters comprise at least one of the following:
a time-domain period;
a start offset;
a length of a first duration; or
a length of a second duration,
wherein the first duration is a duration during which the network device skips data transmission and reception in the at least one discontinuous transmission and reception pattern, and the second duration is a duration during which the network device performs the data transmission and reception in the at least one discontinuous transmission and reception pattern.

13. A communication method, performed by user equipment, the communication method comprising:
receiving configuration information transmitted by a network device, wherein the configuration information is configured to determine configuration parameters of at least one discontinuous transmission and reception pattern corresponding to each of at least one serving carrier; and
receiving first indication information transmitted by the network device, wherein the first indication information is configured to activate a first discontinuous transmission and reception pattern among the at least one discontinuous transmission and reception pattern.

14. The communication method according to claim 13, wherein the first indication information comprises at least one of the following:
at least one first information field;
at least one second information field; or
at least one third information field,
wherein the at least one first information field is configured to indicate activation or inactivation of a corresponding Discontinuous Reception (DRX) pattern, the at least one second information field is configured to indicate activation or inactivation of a corresponding Discontinuous Transmission (DTX) pattern, and the at least one third information field is configured to indicate activation or inactivation of a corresponding DRX and DTX pattern pair.

15. The communication method according to claim 14, wherein at least one of the following cases exists:
a case where each of the at least one first information field is configured to indicate activation or inactivation of a DRX pattern of a corresponding carrier, or is configured to indicate activation or inactivation of a DRX pattern of a corresponding carrier group;
a case where each of the at least one second information field is configured to indicate activation or inactivation of a DTX pattern of a corresponding carrier, or is configured to indicate activation or inactivation of a DTX pattern of a corresponding carrier group; or
a case where each of the at least one third information field is configured to indicate activation or inactivation of a DRX and DTX pattern pair of a corresponding carrier, or is configured to indicate activation or inactivation of a DRX and DTX pattern pair of a corresponding carrier group.

16-17. (canceled)

18. The communication method according to claim 13, wherein the first indication information comprises at least one of the following:
a fourth information field;
a fifth information field; or
a sixth information field,
wherein the fourth information field is configured to indicate inactivation of all Discontinuous Reception (DRX) patterns corresponding to all carriers of the user equipment, the fifth information field is configured to indicate inactivation of all Discontinuous Transmission (DTX) patterns corresponding to all the carriers of the user equipment, and the sixth information field is configured to indicate inactivation of all DRX and DTX pattern pairs corresponding to all the carriers of the user equipment.

19. The communication method according to claim 14, further comprising:
receiving first signaling transmitted by the network device, wherein the first signaling is configured to indicate whether the first indication information comprises at least one of: the at least one first information field, the at least one second information field, the at least one third information field, a fourth information field, a fifth information field, or a sixth information field.

20. The communication method according to claim 13, wherein the first indication information is transmitted via Downlink Control Information (DCI), and the DCI is one of the following:
unicast DCI;
multicast DCI; or
broadcast DCI.

21. The communication method according to claim 13, wherein receiving the first indication information transmitted by the network device comprises:
receiving the first indication information transmitted by the network device on a primary cell, or receiving the first indication information that is applicable to a secondary cell and is transmitted by the network device;
wherein the communication method further comprises one of the following:
monitoring the first indication information on a carrier corresponding to the primary cell in a case where the first indication information is transmitted on the primary cell; or
communicating with the secondary cell according to the first indication information in a case where the first indication information is applicable to the secondary cell.

22. (canceled)

23. The communication method according to claim 13, wherein
the first discontinuous transmission and reception pattern is activated at a moment when the user equipment receives the first indication information;
wherein a second discontinuous transmission and reception pattern is activated after a second time-domain position in a case where second indication information corresponding to the second discontinuous transmission and reception pattern is received at a first time-domain position, wherein the first time-domain position is within a time-domain period of the first discontinuous transmission and reception pattern;
wherein the second time-domain position is one of the following:
a next slot of the first time-domain position;
a slot after a plurality of slots following the first time-domain position;
a moment after the first time-domain position, at which a timer corresponding to the first discontinuous transmission and reception pattern expires; or
a moment after the first time-domain position, at which a first period of the first discontinuous transmission and reception pattern ends, wherein the first period is the time-domain period of the first discontinuous transmission and reception pattern in which the first time-domain position is located.

24-25. (canceled)

26. The communication method according to claim 13, wherein the configuration parameters comprise at least one of the following:
a time-domain period;
a start offset;
a length of a first duration; or
a length of a second duration,
wherein the first duration is a duration during which the network device skips data transmission and reception in the at least one discontinuous transmission and reception pattern, and the second duration is a duration during which the network device performs the data transmission and reception in the at least one discontinuous transmission and reception pattern.

27-28. (canceled)

29. A network device, comprising a processor and a memory, wherein
the memory is configured to store a computer program; and
the processor is configured to execute the computer program to implement the communication method according to claim 1.

30. User equipment, comprising a processor and a memory, wherein
the memory is configured to store a computer program; and
the processor is configured to execute the computer program to:
receive configuration information transmitted by a network device, wherein the configuration information is configured to determine configuration parameters of at least one discontinuous transmission and reception pattern corresponding to each of at least one serving carrier; and
receive first indication information transmitted by the network device, wherein the first indication information is configured to activate a first discontinuous transmission and reception pattern among the at least one discontinuous transmission and reception pattern.

31-32. (canceled)
